(19) United States
(12) Patent Application Publication
(10) Pub. No.: US 2013/0278986 A1
(43) Pub. Date: Oct. 24, 2013

(54) ANNULAR STRUCTURE AND MICRO SCANNING MIRROR

(71) Applicants: BorShiun LEE, Yangmei City (TW); MingFa CHEN, Yangmei City (TW)

(72) Inventors: BorShiun LEE, Yangmei City (TW); MingFa CHEN, Yangmei City (TW)

(73) Assignee: TOUCH MICRO-SYSTEM TECHNOLOGY CORP., Yangmei City (TW)

(21) Appl. No.: 13/542,967

(22) Filed: Jul. 6, 2012

(30) Foreign Application Priority Data
Apr. 19, 2012 (TW) 101113915

(51) Int. Cl. G02B 26/10; G02B 26/08

(52) U.S. Cl. 359/200.6; 359/221.2

(57) ABSTRACT

A micro scanning mirror is disclosed in the present invention. The micro scanning mirror includes a substrate, an annular structure and a mirror structure. The substrate includes a hollow area and a first shaft. The annular structure is disposed inside the hollow area on the substrate and encircles the mirror structure. The mirror structure includes a second shaft connected to the annular structure. The annular structure includes at least one first edge, at least one second edge and a first comb electrode. The first edge is connected to the first shaft, and an end of the second edge is connected to the first edge. The second edge includes a first side adjacent to the mirror structure, and a second side adjacent to the substrate. The first comb electrode is disposed on the second edge.

This application claims priority to Taiwan Patent Application No. 101113915 filed on Apr. 19, 2012.

### CROSS-REFERENCES TO RELATED APPLICATIONS

Not applicable.

### BACKGROUND OF THE INVENTION

1. Field of the Invention

The present invention provides a micro scanning mirror, and more particularly, to a micro scanning mirror that utilizes an annular structure to increase the rotation angle of the mirror without increasing the volume and operation voltage of the components thereof.

2. Descriptions of the Related Art

Conventional micro scanning mirrors are of a single-axis mirror structure. To effectively increase the projection area, a typical practice is to increase the rotation angle of a micro scanning mirror. Conventional approaches to increase the rotation angle of the micro scanning mirror include reducing the mirror area, increasing the operation voltage and increasing the number of electrostatic comb structures. However, the approach of reducing the mirror area will increase the precision requirements of the optical path alignment and increase the cost. Although increasing the operation voltage will not increase the volume of components of the micro scanning mirror, it leads to more power consumption.

Furthermore, increasing the number of electrostatic comb structures can effectively increase the rotation angle of the micro scanning mirror, but disposing the electrostatic comb structures more densely will lead to an increased volume of components of the micro scanning mirror which, in turn, leads to increased air damping when the micro scanning mirror rotates. Consequently, a higher operation voltage must be supplied to overcome the increased air damping due to the increased volume of the components. Because of the increased volume and higher operation voltage, the micro scanning mirror is not environmental friendly and fails to satisfy the demands for lightweight products. Therefore, it is important to produce a micro scanning mirror of good quality that can overcome the aforesaid shortcomings.

### SUMMARY OF THE INVENTION

The primary objective of the present invention is to provide a micro scanning mirror that utilizes an annular structure to increase the rotation angle of the mirror without increasing the volume and operation voltage of components thereof.

To achieve the aforesaid objective, the present invention provides an annular structure disposed between the mirror structure and substrate. The annular structure comprises at least one first edge, at least one second edge, and a first comb electrode. The second edge includes an end connected to the first edge. The second edge comprises a first side and a second side, the first side is adjacent to the mirror structure and the second side is adjacent to the substrate. The first comb electrode is disposed on the second edge.

To achieve the aforesaid objective, the present invention provides a micro scanning mirror, which comprises a substrate, an annular structure and a mirror structure. The substrate comprises a hollow area and a first shaft. The annular structure is disposed inside the hollow area of the substrate and covers the mirror structure. The mirror structure comprises a second shaft connected to the annular structure. The annular structure comprises at least one first edge connected to the first shaft, at least one second edge and a first comb electrode. The second edge includes an end connected to the first edge. The second edge comprises a first side and a second side, the first side is adjacent to the mirror structure and the second side is adjacent to the substrate. The first comb electrode is disposed on the second edge.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a top view of the micro scanning mirror according to the first embodiment of the present invention;

FIG. 2 is a top view of a micro scanning mirror according to the second embodiment of the present invention;

FIG. 3 is a top view of a micro scanning mirror according to the third embodiment of the present invention; and

FIG. 4 and FIG. 5 are schematic views of partial appearances of the micro scanning mirror according to the third embodiment of the present invention at different vibrating frequencies respectively.

### DESCRIPTION OF THE PREFERRED EMBODIMENT

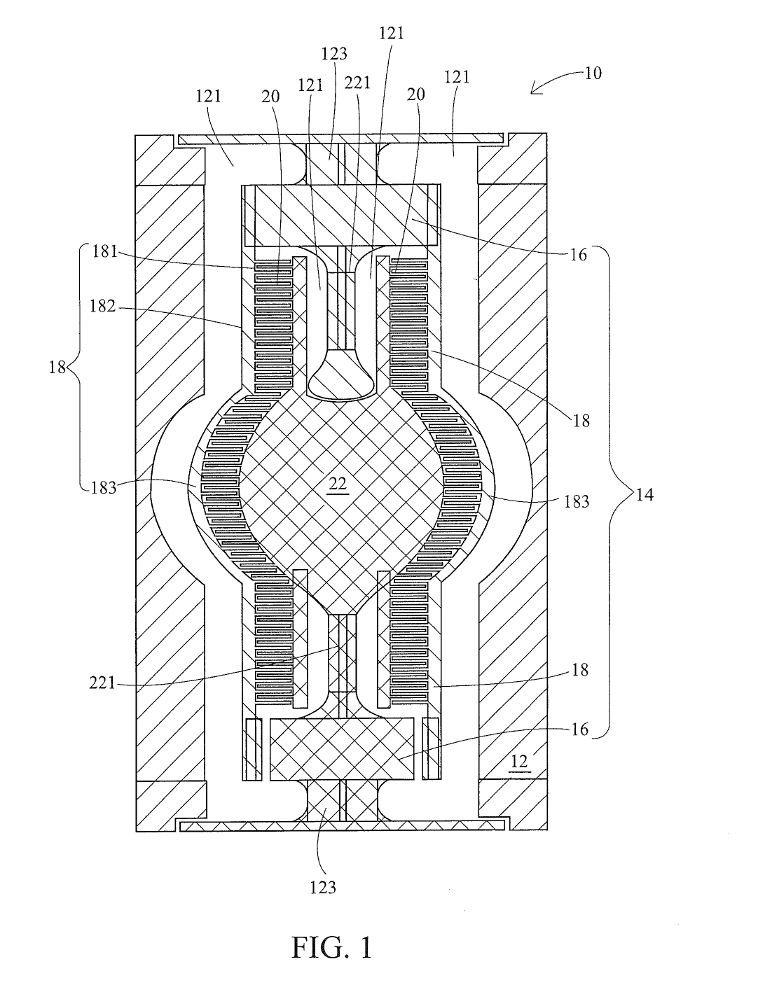

FIG. 1 illustrates a top view of the micro scanning mirror 10 according to the first embodiment of the present invention. The micro scanning mirror 10 comprises a substrate 12, which has a hollow area 121 and a first shaft 123. The micro scanning mirror 10 further comprises an annular structure 14 disposed in the hollow area 121 of the substrate 12. The annular structure 14 comprises two first edges 16, two second edges 18 and a first comb electrode 20.

The micro scanning mirror 10 further comprises a mirror structure 22. The mirror structure 22 has a second shaft 221 connected to the annular structure 14 so that the mirror structure 22 is disposed to rotate in the annular structure 14. In other words, the annular structure 14 can be used to cover the mirror structure 22, and the design features of the annular structure 14 is used in the micro scanning mirror 10 to increase the rotation angle of the mirror structure 22.

The two first edges 16 are connected between the first shaft 123 and the second shaft 221 respectively. The two second edges 18 each have one end connected to two ends of one of the first edges 16 respectively; and due to the hollow area 121, the other end of each of the two second edges 18 do not make direct contact with the other first edge 16 to achieve the purpose of electric insulation.

Each of the second edges 18 has a first side 181 and a second side 182. The second side 182 is adjacent to the substrate 12, and the first side 181 is opposite the second side 182, i.e., located on the second edge 18 at a location adjacent to the mirror structure 22. The first comb electrode 20 is disposed on the first side 181 of the second edge 18 according to the design requirements. In the first embodiment of the present invention, no comb electrode is disposed on the second side 182.

Additionally, each of the second edges 18 further has an arc portion 183. The arc portion 183 is located adjacent to the mirror structure 22, and has a curvature corresponding to a curvature of the mirror structure 22. Therefore, when rotating relative to the annular structure 14, the mirror structure 22 will not be damaged due to collision with the second edge 12 during the rapid rotation process.

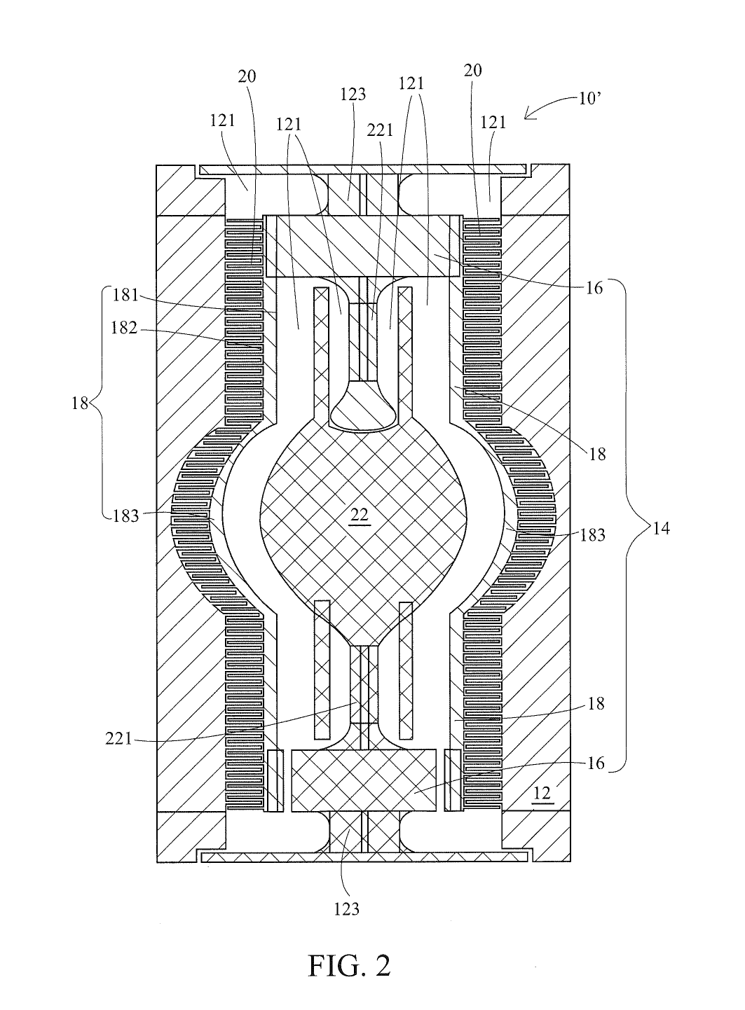

FIG. 2 illustrates a top view of the micro scanning mirror 10′ according to the second embodiment of the present invention. In the second embodiment, components bearing the same reference numerals as those of the first embodiment also have the same structures and functions, and thus, will not be described again herein. The second embodiment differs from the first embodiment in that the first comb electrode 20 of the micro scanning mirror 10′ is disposed on the second side 182 of the second edge 18. The operation characteristics of the first embodiment and the second embodiment will be described later.

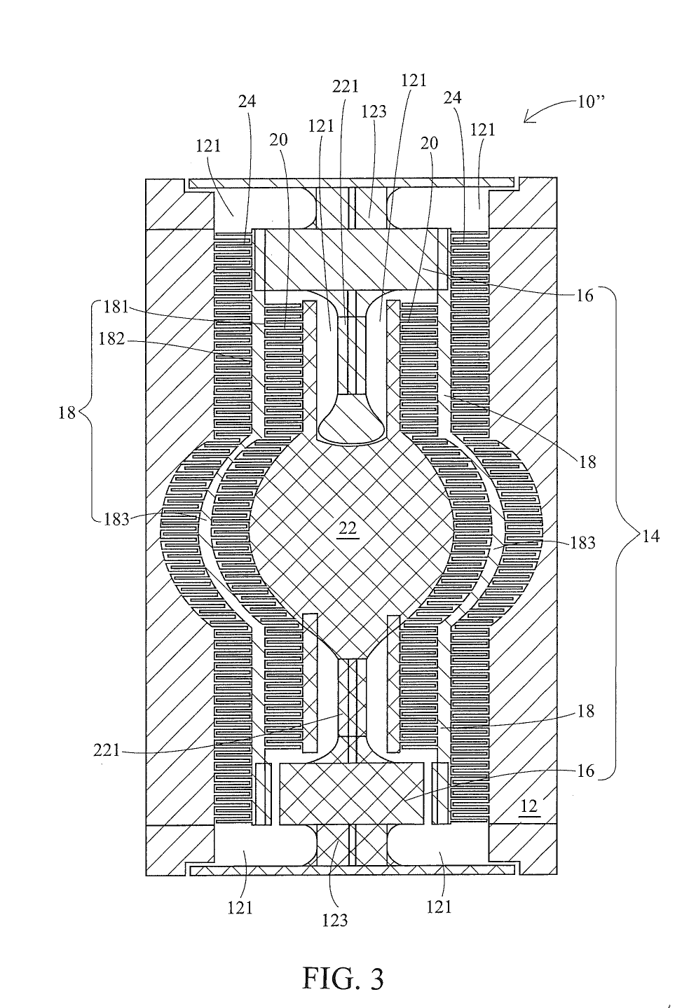

FIG. 3 illustrates a top view of the micro scanning mirror 10″ according to the third embodiment of the present invention. The third embodiment differs from the previous embodiments in that the annular structure 14 may further comprise a second comb electrode 24. The second comb electrode 24 and the first comb electrode 20 are selectively disposed on two sides of the second edge 18 respectively. For example, the first comb electrode 20 is disposed on the first side 181 and the second comb electrode 24 is disposed on the second side 182, or the first comb electrode 20 is disposed on the second side 182 and the second comb electrode 24 is disposed on the first side 181.

As shown in FIGS. 1 to 3, both the top end and bottom end of the first shaft 123 are electrically insulated from the substrate 12. Both of the second edges 18 have a top end and is connected to the first edge 16 disposed above the mirror structure 22, and have a bottom end electrically insulated from the first edge 16 disposed below the mirror structure 22 due to the hollow area 121. Additionally, the mirror structure 22 is connected to the first edge 16 disposed therebelow by means of the second shaft 221 and is separated from the first edge 16 that is disposed thereabove.

Therefore, when an operation voltage is supplied to the micro scanning mirror 10, 10′ or 10″ by a user, the first voltage difference is generated between the substrate 12 and the annular structure 14 and a second voltage difference is generated between the annular structure 14 and the mirror structure 22 to cause relative rotation. Besides, the first comb electrode 20 and the second comb electrode 24 may be selectively disposed on two sides (i.e., the first side 181 and the second side 182) of the second edge 18 respectively to amplify the amplitudes of the voltage differences. Taking the third embodiment as an example, an additional group of comb electrodes may be disposed in the micro scanning mirror 10″ so that when the same operation voltage is supplied, a driving force as large as twice of that of the prior art can be obtained in the micro scanning mirror 10″.

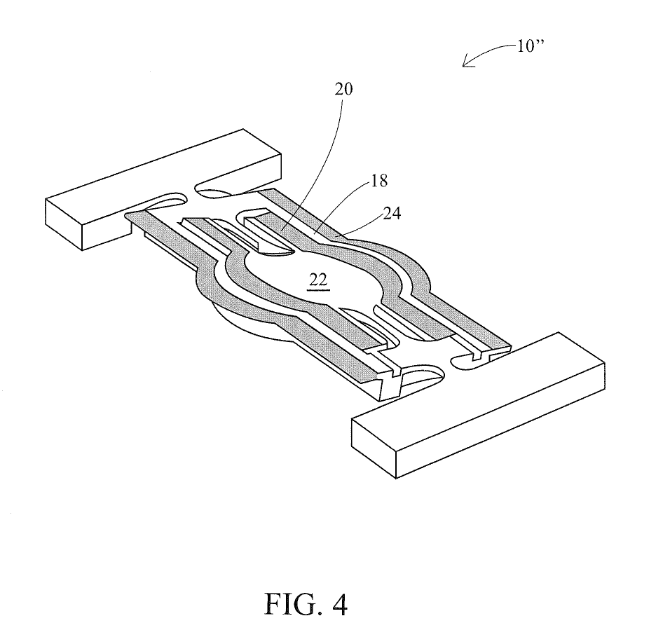

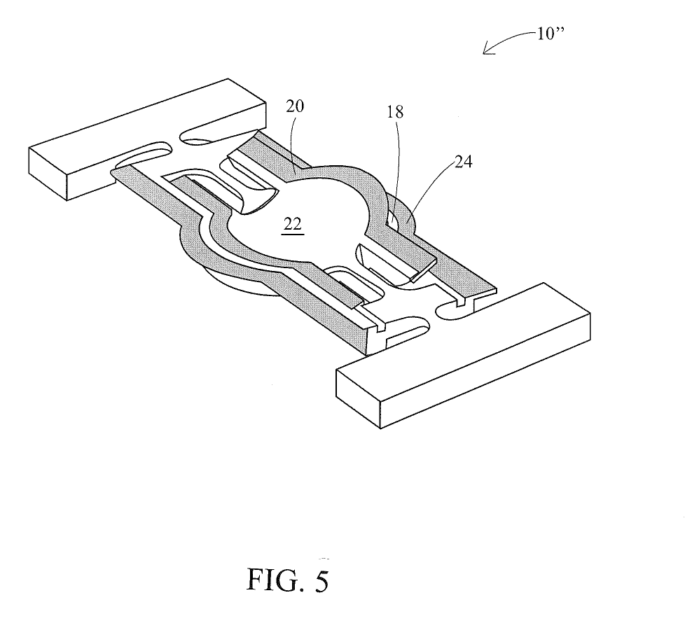

FIGS. 4 and 5 illustrate schematic views of partial appearances of the micro scanning mirror 10″ according to the third embodiment of the present invention at different vibrating frequencies respectively. During operation of the micro scanning mirror 10″, the annular structure 14 drives the mirror structure 22 to vibrate relative to the substrate 12 in the same or reverse direction. The first comb electrode 20 and the second comb electrode 24 can effectively increase the driving force to increase the rotation angle of the mirror structure 22.

As shown in FIG. 4, when an operation voltage of 60 V is supplied to the micro scanning mirror 10″ of the third embodiment and a vibrating direction of the annular structure 14 relative to the mirror structure 22 is the same as the vibration direction of the annular structure 14 relative to the substrate 12, the vibrating frequency of the micro scanning mirror 10″ is about 16.5 kHz and the rotation angle of the mirror structure 22 relative to the substrate 12 is up to about 7.2°.

As shown in FIG. 5, when an operation voltage of 60 V is supplied to the micro scanning mirror 10″ of the third embodiment and the vibrating direction of the annular structure 14 relative to the mirror structure 22 is reverse as compared to the vibration direction of the annular structure 14 relative to the substrate 12, the vibrating frequency of the micro scanning mirror 10″ is about 28.5 kHz.

According to the above descriptions, because an annular structure is additionally provided in the micro scanning mirror of the present invention, the micro scanning mirror can operate at two different vibrating frequencies during operation. The user may choose an appropriate vibrating frequency depending on the practical needs to effectively utilize the mirror structure to generate a maximum rotation angle corresponding to the vibrating frequency. Apart from supplying an operation voltage to drive the mirror structure by means of an electrostatic force, the mirror structure may also be driven by a magnetic force or through the use of piezoelectric driving technologies depending on the design requirements.

The annular structure of the micro scanning mirror of the present invention is of a single-axis design, so there are two vibrating frequencies for choice. The annular structure of the micro scanning mirror of the present invention may also be designed as a dual-axis structure so that the micro scanning mirror has four vibrating frequencies correspondingly. The number of axes in the micro scanning mirror of the present invention is determined by the design requirements, and will not be further detailed herein. Because the micro scanning mirror of the present invention can be designed to have an arbitrary number of vibrating frequencies, a plurality of scanning frequencies can be provided by a single micro scanning mirror in a scanning device through the use of differences between the vibrations of the annular structure relative to the substrate and the mirror structure and through the design of the number of shafts of the annular structure connected to the mirror structure and the substrate.

In various embodiments of the present invention, a number of parameters of the micro scanning mirror may be adjusted by the user to achieve expected vibrating frequencies to provide the scanning device with appropriate scanning frequencies. For example, given a constant operation voltage, the twisting extents of the annular structure relative to the mirror structure and the substrate are directly affected by the lengths and thicknesses of the first shaft 123 and the second shaft 221. The adjustment of the area and thickness of the annular structure will alter the weight and air damping thereof, so the vibrating frequencies of the micro scanning mirror may also be adjusted. Similar to the adjustment of the area and the thickness of the annular structure, the vibrating frequencies of the micro scanning mirror can be adjusted by adjusting the area and the thickness of the mirror structure to alter the weight and the air damping.

As compared to the prior art, an annular structure is disposed between the mirror structure and the substrate in the present invention. The mirror structure, the annular structure and the substrate are not in electrical communication with each other but are rotatably connected with each other. When a preset operation voltage is supplied to the micro scanning mirror, a single-axis annular structure can vibrate in the same or reverse directions to the mirror structure and to the substrate so that the micro scanning mirror with the single-axis annular structure can have two different scanning frequencies. On the other hand, a dual-axis annular structure can also vibrate in the same or reverse direction relative to the mirror structure and to the substrate so that the micro scanning mirror with the dual-axis annular structure can further have four different scanning frequencies.

Accordingly, the micro scanning mirror of the present invention can effectively increase the rotation angle of the mirror structure without increasing the volume and the operation voltage of the components, and further satisfy the environmental protection requirements of saving power. Moreover, the micro scanning mirror adopting the annular structure can have a plurality of vibrating frequencies so that the user can choose a vibrating frequency as desired to obtain the maximum rotation angle corresponding to the vibrating frequency.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An annular structure disposed between a mirror structure and a substrate, the annular structure comprising:
at least one first edge;
at least one second edge, which includes an end connected to the first edge, the second edge further comprising a first side and a second side, the first side being adjacent to the mirror structure and the second side being adjacent to the substrate; and
a first comb electrode disposed on the second edge.

2. The annular structure of claim 1, wherein the first comb electrode is disposed on the first side.

3. The annular structure of claim 2, wherein the annular structure further comprises a second comb electrode disposed on the second side.

4. The annular structure of claim 1, wherein the first comb electrode is disposed on the second side.

5. The annular structure of claim 4, further comprising a second comb electrode disposed on the first side.

6. The annular structure of claim 1, further comprising two second edges respectively connected to two ends of the first edge.

7. The annular structure of claim 1, wherein the second edge comprises an arc portion, and a curvature of the arc portion corresponds to a curvature of the mirror structure.

8. A micro scanning mirror comprising:
a substrate, comprising a hollow area and a first shaft;
an annular structure disposed inside the hollow area of the substrate, the annular structure comprising:
at least one first edge connected to the first shaft;
at least one second edge, which includes an end connected to the first edge, the second edge comprising a first side and a second side, the second side being adjacent to the substrate, and the first side being located at a position opposite to the second side; and
a first comb electrode disposed on the second edge; and
a mirror structure, comprising a second shaft connected to the annular structure, the annular structure covering the mirror structure, and the first side being adjacent to the mirror structure.

9. The micro scanning mirror of claim 8, wherein the first comb electrode is disposed on the first side.

10. The micro scanning mirror of claim 9, wherein the annular structure further comprises a second comb electrode disposed on the second side.

11. The micro scanning mirror of claim 8, wherein the first comb electrode is disposed on the second side.

12. The micro scanning mirror of claim 11, wherein the annular structure further comprises a second comb electrode disposed on the first side of the second edge.

13. The micro scanning mirror of claim 8, wherein the annular structure further comprises two second edges respectively connected to two ends of the first edge.

14. The micro scanning mirror of claim 8, wherein the second edge comprises an arc portion, and a curvature of the arc portion corresponds to a curvature of the mirror structure.
